(19) United States
(12) Patent Application Publication
(10) Pub. No.: US 2006/0146465 A1
(43) Pub. Date: Jul. 6, 2006

(54) Protective switch

(75) Inventor: Wolfgang Esser, Hennef (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Moeller GmbH, Bonn (DE)

(21) Appl. No.: 10/536,370

(22) PCT Filed: Nov. 22, 2003
(86) PCT No.: PCT/EP03/13130

§ 371 Date: Feb. 23, 2006

(30) Foreign Application Priority Data
Nov. 27, 2002 (DE) 102 55 168.5

(51) Int. Cl. H02H 3/08

(52) U.S. Cl. 361/93.1

(57) ABSTRACT

A protective circuit-breaker comprising includes an operating mechanism for closing and opening main contacts. An evaluation unit is provided for processing a measured value of the phase current, comparing the processed measured value to an adjustable fault criterion, and tripping the operating mechanism via a trip solenoid by outputting a trip signal when the fault criterion is exceeded. A measuring terminal is connected to the evaluation unit at an input side thereof and configured to supply a monitored electrical quantity supplied by a temperature-dependent resistor connected to a motor-driven system supplied via the protective circuit-breaker. The evaluation unit includes a measuring device for measuring a change in the monitored electrical quantity and for outputting a trip signal when the monitored electrical quantity exceeds a predefined limit.

### FIELD OF THE INVENTION

The present invention relates to a protective circuit-breaker, in particular, a motor-protective circuit breaker, including an operating mechanism for closing and opening main contacts, current sensors for measuring the phase currents, and further including an evaluation unit which processes the measured values of the phase currents, compares the same to adjustable fault criteria, and trips the operating mechanism via a trip solenoid by outputting a trip signal when the fault criteria are exceeded.

### BACKGROUND INFORMATION

In accordance with German Publication DE 35 45 930 A1, motor-protective circuit breakers have a multipole design and are provided with a corresponding number of main contacts. The main contacts are closed and opened via an operating mechanism either manually or by a motor drive. In the event of a permanent overload or a brief short-circuit current, bimetal trip mechanisms or magnetic trip mechanisms are caused to operate, said trip mechanisms in turn releasing the latching mechanism connected to the operating mechanism, and thereby tripping the operating mechanism, causing the main contacts to open.

German Publication DE 43 23 356 C1 discloses a low-voltage circuit-breaker including an electronic evaluation unit. The instantaneous values of the phase currents flowing across the main contacts are measured by electromagnetic current sensors and evaluated by the evaluation unit. A delayed trip signal is supplied to a trip solenoid when adjustable overload values are exceeded, and a substantially undelayed trip signal is supplied to said trip solenoid when a short-circuit occurs, the armature of said trip solenoid then releasing the latching mechanism, thereby causing the operating mechanism to trip.

It is generally known, for example, from German Publication DE 93 02 254 U1, to connect motor-protective circuit breakers to signaling devices which indicate a short-circuit or overload trip condition via auxiliary switches.

German Publication DE 37 28 197 A1 discloses an electronic motor protection relay which outputs a trip signal in the event of overloading which could endanger or overheat the motor to be protected. This trip signal de-energizes a contactor which turns off the motor. The motor protection relay has an electronic evaluation unit which, on the one hand, is supplied via current transformers with measurement signals proportional to the phase currents and, on the other hand, is connected to a thermistor disposed in the motor. The evaluation unit checks the incoming signals for short-circuit, overload, asymmetry, phase failure, and overtemperature. If the signals exceed fixed criteria, a trip signal is output to switch off the contactor.

### SUMMARY OF THE INVENTION

The object of the present invention is to improve the protection of motor-driven systems.

In accordance with the present invention, by evaluating a monitored electrical quantity which is supplied by a temperature-dependent resistor connected to the motor-driven system to be switched and protected, and by switching off the motor when a critical temperature inside the motor-driven system is exceeded, the enhanced evaluation unit provides a protective function in addition to the usual protective function, which is based on the evaluation of the motor current. The temperature-dependent resistor, such as a thermistor, is installed either in the motor itself, or inside the driven system, for example, at a temperature-critical bearing location. The protective circuit-breaker of the present invention provides a convenient alternative to the known combination of a contactor and an electronic motor protection relay with thermistor monitoring function. The present invention effectively combines the direct thermistor monitoring function with the disconnector- and main-switch characteristics, such as lockability of the handle of the protective circuit-breaker.

In advantageous refinements of the present invention, an auxiliary relay and/or a light-emitting element is/are connected to the evaluation unit. In the first case, an overtemperature occurring in the motor-driven system is remotely indicated as an electrical signal via the auxiliary relay contact and associated signaling terminals, while in the second case, it is indicated locally as a visual signal. The auxiliary relay and, if present, the light-emitting element can advantageously be disposed in an add-on module to be attached to the protective circuit-breaker.

### BRIEF DESCRIPTION OF THE DRAWINGS

Further details and advantages of the present invention will become apparent from the exemplary embodiment described below with reference to the Figures, in which:

FIG. 1 is a three-dimensional representation of an embodiment of the protective circuit-breaker according to the present invention;

FIG. 2 is a schematic diagram of the protective circuit breaker of FIG. 1.

### BEST MODE OF IMPLEMENTING THE INVENTION

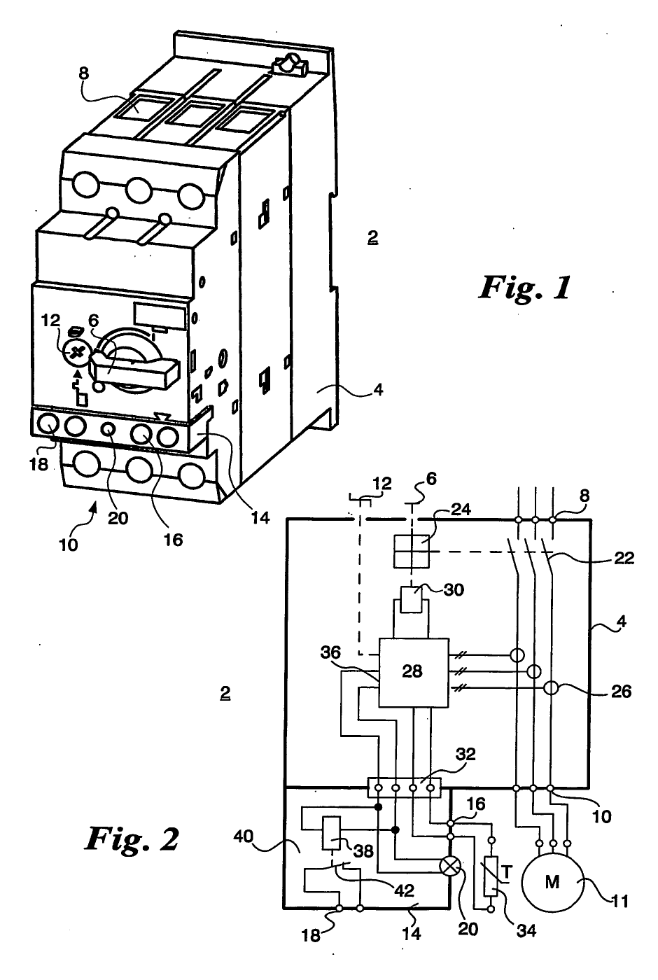

FIG. 1 shows a three-pole motor-protective circuit breaker in the form of a protective circuit-breaker 2 having a breaker enclosure 4, a rotary ON/OFF handle 6 mounted on the front, main input terminals 8 for incoming feeders and main output terminals 10 for supply lines to a motor as a load. A adjusting control 12 is mounted on the front. An add-on module 14 is snap-fitted to breaker enclosure 4 from the front. Add-on module 14 has two measuring terminals 16 and two signaling terminals 18, as well as an LED-type light-emitting element 20.

According to FIG. 2, main incoming terminals 8 are separably connected to main load-side terminals 10 inside breaker enclosure 4 via contacts 22 for all three poles. Load-side terimals 10 are connected to a motor 11 of a motor-driven system (not shown in detail), such as a production machine. Main contacts 22 are opened and closed via an operating mechanism 24 (also referred to as switch mechanism) either by handle 6, or automatically opened when the phase currents flowing across main contacts 22 exceed adjustable fault criteria.

The instantaneous values of the phase currents are each measured by a current sensor 26, such as an electromagnetic current transformer, and supplied to an electronic evaluation unit 28. Evaluation unit 28 converts the measured current values to digital data and compares the same to an adjustable fault criterion, such as a limit value for the permissible overload of motor 11. The relevant fault criterion is set by adjusting control 12, for example, by the adjusting control acting on an adjustable resistor of evaluation unit 28. When the fault criterion set is exceeded, evaluation unit 28 outputs a trip signal for energizing a trip solenoid 30, whose armature then causes operating mechanism 24 to trip, after which main contacts 22 are opened, thus automatically switching off motor 11.

Add-on module 14 connected to breaker enclosure 4 is in electrical communication with evaluation unit 28 via a connector 32. A temperature-dependent resistor in the form of a thermistor 34 is embedded as a thermal sensor in the stator of motor 11. The monitored electrical quantity supplied by thermistor 34 (current, voltage or resistance) is fed to evaluation unit 28 via measuring terminals 16. The monitored quantity, for example, the resistance value, is continuously monitored by evaluation unit 28. If the monitored quantity exhibits a significant change due to an excessive temperature rise of motor 11, then, in this case too, evaluation unit 28 outputs a signal which energizes trip solenoid 30. This causes operating mechanism 24 to trip, after which main contacts 22 are opened, as a result of which motor 11, which is prone to damage by heat, is switched off.

The inventive protective circuit-breaker 2 has the usual protective features against overloading and, if necessary, against short-circuit, and provides additional protection by evaluating the motor temperature directly measured by thermistor 34. Once the monitored quantity supplied by thermistor 34 exceeds the limit value, light-emitting element 20 is turned on via activated outputs 36 of evaluation unit 28, so that the exceeding of the allowable temperature in motor 11 is visually indicated at protective circuit-breaker 2. At the same time, relay coil 38 of an auxiliary relay 40 disposed in add-on module 14 is energized via activated outputs 36, thereby operating the associated relay contact 42. Thus, when motor 11 is switched off, the exceeding of the allowable motor temperature can be remotely indicated via signal lines which are connected to signaling terminals 18 connected to relay contact 42.

The present invention is not limited to the application described above. Thus, the quantity monitored by evaluation unit 28 may be obtained, for example, from a temperature-dependent resistor installed at a critical point within the machine or system driven by motor 11, especially on a bearing that is prone to running hot.

The present invention is not limited to the above-described embodiment either. Thus, measuring terminals 16, signaling terminals 18, light-emitting element 20, and auxiliary relay 40 do not necessarily have to be part of an add-on module, but can be connected to breaker enclosure 4 individually, in combination, or all together. In more economical embodiments of protective circuit-breaker 2, light-emitting element 20 or auxiliary relay 40 and signaling terminals 18 can be omitted.

### LIST OF REFERENCE NUMBERALS

2 protective circuit-breaker
4 breaker enclosure
6 handle
8; 10 main terminals
11 motor
12 adjusting control
14 add-on module
16 measuring terminals
18 signaling terminals
20 light-emitting element
22 main contacts
24 operating mechanism
26 current sensors
28 evaluation unit
30 trip solenoid
32 connector
34 thermistor
36 outputs
38 relay coil
40 auxiliary relay
42 relay contact

1-4. (canceled)

5. A protective circuit-breaker comprising:
an operating mechanism configured to close and open main contacts;
a current sensor configured to measure a phase current;
an evaluation unit configured to process a measured value of the phase current, compare the processed measured value to an adjustable fault criterion, and trip the operating mechanism via a trip solenoid by outputting a trip signal when the fault criterion is exceeded; and
a measuring terminal connected to the evaluation unit at an input side thereof and configured to supply a monitored electrical quantity supplied by a temperature-dependent resistor connected to a motor-driven system supplied via the protective circuit-breaker;
wherein the evaluation unit includes a measuring device configured to measure a change in the monitored electrical quantity and to output a trip signal when the monitored electrical quantity exceeds a predefined limit.

6. The protective circuit-breaker as recited in claim 5 wherein the evaluation unit is configured to energize an auxiliary relay when the monitored electrical quantity exceeds the predefined limit.

7. The protective circuit-breaker as recited in claim 6 further comprising a signaling terminal connected to the auxiliary relay at an output side thereof, and wherein the signaling terminal and the auxiliary relay are disposed in an add-on module connectable to a breaker enclosure of the protective circuit-breaker.

8. The protective circuit-breaker as recited in claim 5 further comprising a light-emitting element, and wherein the evaluation unit is configured to activate the light-emitting element when the monitored electrical quantity exceeds the predefined limit.

9. The protective circuit-breaker as recited in claim 6 further comprising a light-emitting element, and wherein the evaluation unit is configured to activate the light-emitting element when the monitored electrical quantity exceeds the predefined limit.

10. The protective circuit-breaker as recited in claim 7 further comprising a light-emitting element, and wherein the evaluation unit is configured to activate the light-emitting element when the monitored electrical quantity exceeds the predefined limit.
